(19) United States
(12) Patent Application Publication
(10) Pub. No.: US 2002/0127994 A1
(43) Pub. Date: Sep. 12, 2002

(54) 911 Celphinder

(76) Inventor: Sydney Devlin Stanners, Sidney (CA)

Correspondence Address: SYDNEY D. SYANNERS, 102 9901 FOURTH STREET, SIDNEY, CA

(21) Appl. No.: 10/092,600

(22) Filed: Mar. 8, 2002

Related U.S. Application Data
(60) Provisional application No. 60/274,207, filed on Mar. 9, 2001.

(51) Int. Cl. H04M 11/00

(52) U.S. Cl. 455/404; 455/426

(57) ABSTRACT

This invention relates to a novel method of providing location data of a 911 call placed by a cellular telephone. More particularly, this invention relates to combining transmitting circuitry in the cellular telephone and receiving circuitry in the landline telephone. When a 911 cellular telephone call is placed within proximity of a landline telephone i.e. the same house, apartment, office, business, school etc., an interaction takes place between the two enabled telephones. Upon receiving and decoding the RF transmission from the cell telephone—initiated by dialing 911—a pre-dialer, connected to the landline transmits the 911 call. The result is the landline customers ID [address] data being immediately displayed on the 911 operators' screen.

Note: Type of transmission is available: radio wave transmission including spread spectrum, infra red, Blue Tooth.

### BACKGROUND OF INVENTION

When a 911 call is placed from a landline telephone, the address of the landline telephone is immediately displayed on the 911 operators' screen. This action occurs although the caller has not verbally communicated with the 911 operator. When a 911 call is placed from a cellular telephone, the callers' location does not show on the screen, and unless verbal communication takes place between the 911 operator and the caller, the location source of the 911 call (and therefore, the caller) will remain unknown. In other cases, the caller communicates with the 911 operator, but is unable to provide the operator with their location data.

The Federal Communications Commission (FCC) has mandated that cell phone carriers must automatically provide the location of 911 calls [made from a cell phone] to public safety answering points to within certain accuracy parameters [i.e 50 meters 67% of the time and within 100 meters 95% of the time]. The deadline for implementation of this service was October 2001.

Several companies are responding to this challenge by using Global Positioning Signal (GPS) or Time Distance of Arrival (TDOA) between cell towers to provide location data. These technologies are achieving limited success with their ability to consistently provide accurate location data in urban areas—and in rural settings—sometimes missing the target by several hundred feet, especially when cell phones are deployed in residences, apartments and office towers, warehouses, factories and schools etc. Failure to provide precise location data of the scene of the emergency [call] could place the caller's life in jeopardy.

Office Buildings and Towers

When a 911 call is made from a [landline] office telephone that is connected to the landline via a PBX type master switching box—the street address alone appears on the 911 operators screen.

For example, a 911 call placed from the 35^{th} floor of a 50 floor office tower i.e. 3526 410-12^{th} Ave. S.W. Anytown, would show on the 911 operators screen as: 410-12^{th} Ave. Anytown. The responding police officer would not know the call was placed from office No. 3526, unless the caller completed the call by speaking with the responding 911 operator

In many cases—due to illness, armed robbery or assault etc., the caller has dialed 911, but is unable to speak with the 911 operator. Therefore, the individual office address—or floor number—does not show on the operator's screen. Lack of precise location data could put the caller's life in jeopardy.

Work Alone Personnel

Violence in the workplace is an ongoing problem, especially for work alone personnel. These workers would benefit from a safety technology that would allow them to surreptitiously contact, and provide police with their location data. Being able to contact police without alerting the aggressor could be a valuable asset. In many instances, an overt “call” for help could trigger a violent reaction from an actual or potential aggressor.

### BRIEF SUMMARY OF THE INVENTION

This invention enables a 911 Call Center to automatically source the [address] of an incoming 911 call made from a cellular telephone. To accomplish this task, 911 CELPHINDER shares the telephone company subscribers I.D., already imbedded into subscribers' landline telephone system.

The invention works by combining the appropriate circuitry—transmitter/receiver, pre-dialer, and/or transceiver—with both cell and landline telephone systems.

When a 911 call phone call is made from an enabled cell phone within proximity of an enabled landline telephone i.e. same house, apartment, office, business, school etc. an interaction is initiated between the cell phone and landline telephone.

Originally designed to give precise location data inside problem buildings, i.e. office and apartment towers, 911 CELPHINDER will work in any location within cell phone range of a cell tower.

911 CELPHINDER will also work where normal cell phone transmissions are blocked, out of range, or in areas not serviced by a cell phone network. Under these circumstances, it is necessary only for the cell phone to communicate with the landline telephone.

The 911 CELPHINDER transmitter technology is attached to the cellular telephone either by an Interface Module or built in chipset. The landline telephone is equipped with receiving/pre-dialing technology that communicates with the enabled cell phone. Alternatively, the landline telephones circuitry is housed in, or attached to the telephone wall jack. Upon receiving and decoding the cell phone transmission—initiated upon dialing 911 on the cell phone—the landline receiving/monitoring technology triggers the pre-dialer, and initiating a 911 call to the 911 operator. The landline subscribers' location address, data [imbedded on the landline] is immediately displayed on the operator's screen and is furnished to responding police officers. Any, of a number of other locating technologies—for example GPS chip is added to the 911 CELPHINDER enabled cell phone. This further enhances the overall effectiveness of the System by furnishing location data when a 911 CELPHINDER enabled landline is unavailable.

911 CELPHINDER enables responding police officers to go directly to the source of the emergency. Police officers responding to GPS or TDOA type location data might have to search dozens—or even hundreds of apartments or offices—before finding the 911 caller. 911 CELPHINDER is primarily designed to give the [address] of the emergency. Other technologies TDOA, GPS etc give a latitude/longitude reference to the 911 call. Depending on the terrain, building structure, signal attenuation etc. the reference point can be several hundred feet from the 911 call.

### Office Buildings and Towers

911 Celphinder Enabled Landline Telephone

In order to provide precise location data to landline telephones if office towers and other buildings using PBX type master switching boxes, the following technological changes are made.

A business line bypasses the PBX switch that terminates at the office junction box is installed. The business line contains the imbedded 911 location (address) data.

A 911 CELPHINDER monitoring and pre-dialing circuitry is installed at the junction box/phone jack. 911 CELPHINDERS transmitter circuitry is installed in the landline telephone.

When 911 is dialed, the 911 sequence triggers the transmitter in the landline telephone. The transmitted signal is received by the Systems monitor at the junction box/phone jack.

When a 911 call is placed on a 911 CELPHINDER enabled landline telephone, the 911 CELPHINDER transmission and reception sequence take place, activating the pre-dialer that initiates the 911 call, providing full address data to the 911 operator, enabling responding police officers to go directly to the source of the 911 call. A 911 call placed by a 911 CELPHINDER enabled cellular telephone from the same office will obtain the same result.

To protect work alone personnel, the worker wears a battery powered Triggering Key. When activated (by squeezing etc.) the Triggering Key transmits an (RF) signal. The signal is received by the 911 CELPHINDER cell phone that has a receiver/monitoring circuit added to the Interface Module (or built into the cell phone in a chipset format). The added circuit initiates the 911 dialing sequence, that in turn triggers and transmits the RF signal to the landline monitoring circuitry, that results in a 911 call (and subscribers data) being received by the 911 operator. Or the Triggering Key is coded with the same frequency used by the enabled cell phone, and communicates directly with the enabled landline telephone, wall jack or junction box, initiating the pre-dialing sequence.

### DRAWINGS

FIG. 1 Showing transmission from enabled cell phone to enabled landline telephone/wall jack.

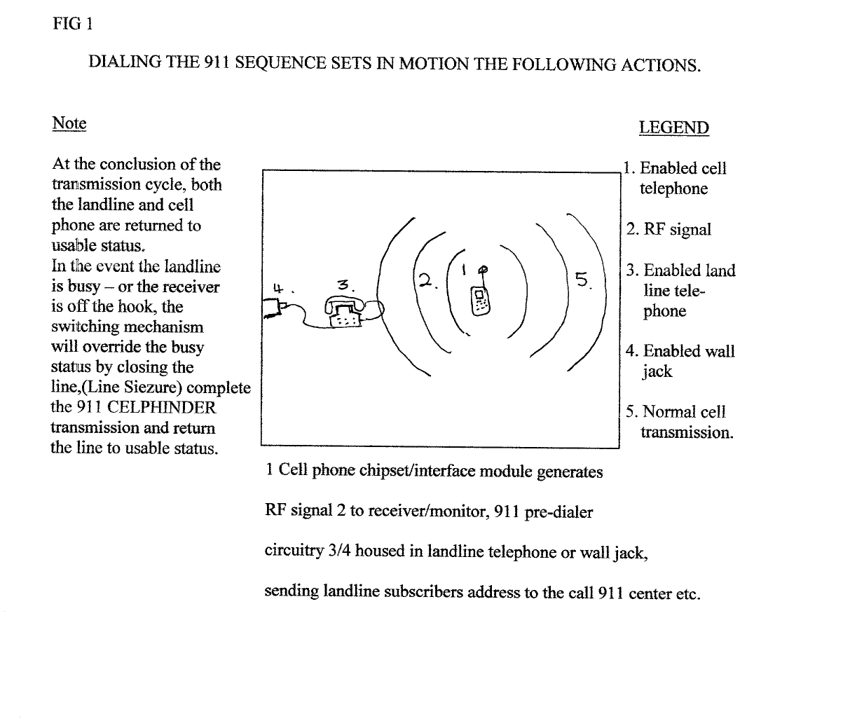

FIG. 2 Showing transmission (by transceiver) from cell phone to landline telephone/wall jack.

FIG. 2A Showing 2^{nd} sequence of transmission (from enabled wall jack/landline telephone to enabled cell phone—the relayed to cell tower etc.

FIG. 3 Showing converted landline telephone dialing sequence (911) initiates transmission to enabled junction box.

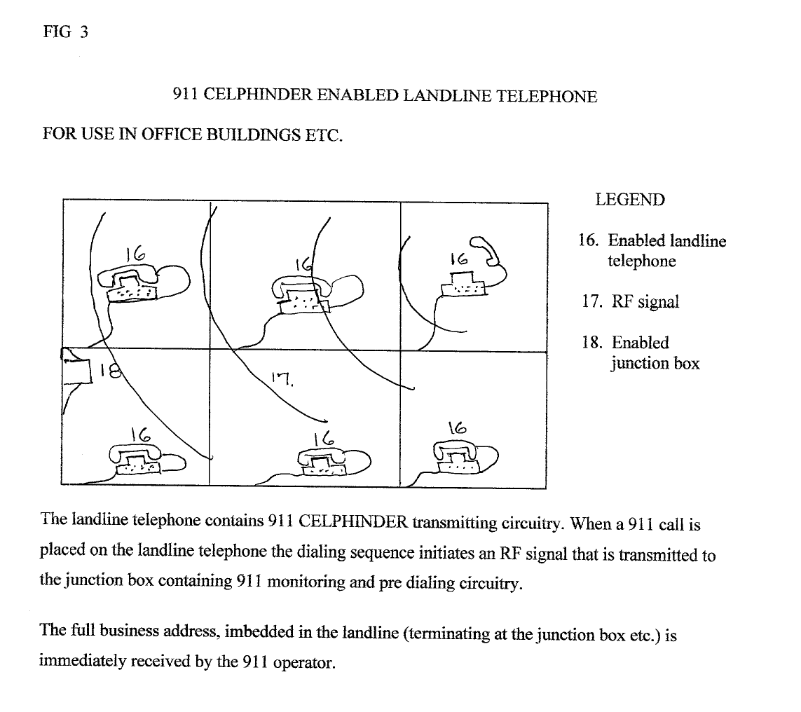

FIG. 4 Showing lone worker activating Triggering Key. Transmission (same 911 CELPHINDER frequency transmission frequency) received at enable wall jack or landline telephone.

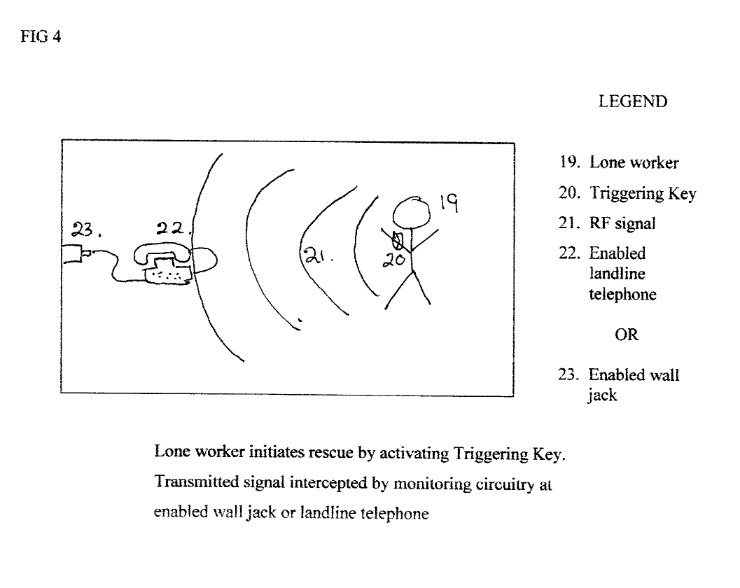

FIG. 5 Showing lone worker activating Triggering Key, transmission received by cell phone and relayed to enabled wall jack/landline telephone.

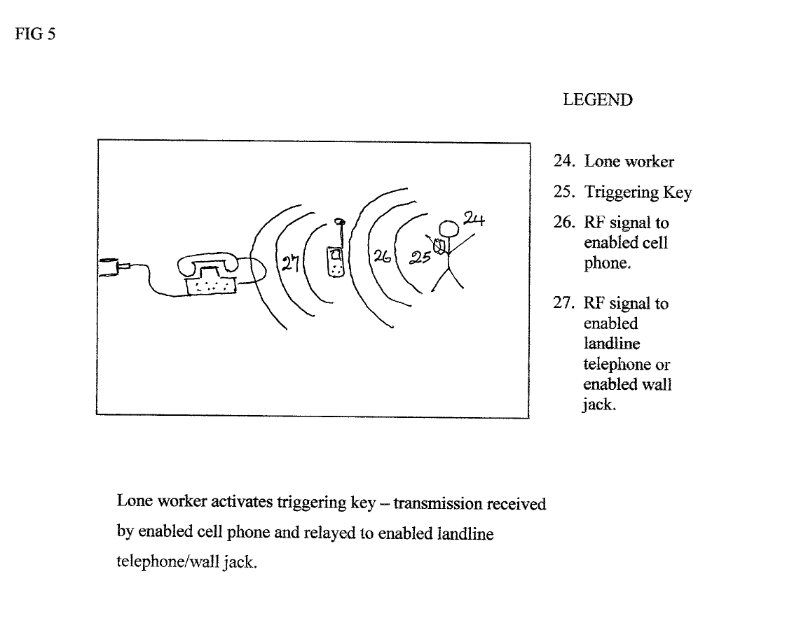

FIG. 6 Showing lone worker activating Triggering Key in office (tower) containing converted landlines (see No. 3 above): Transmission from Triggering Key received by enabled junction box circuitry.

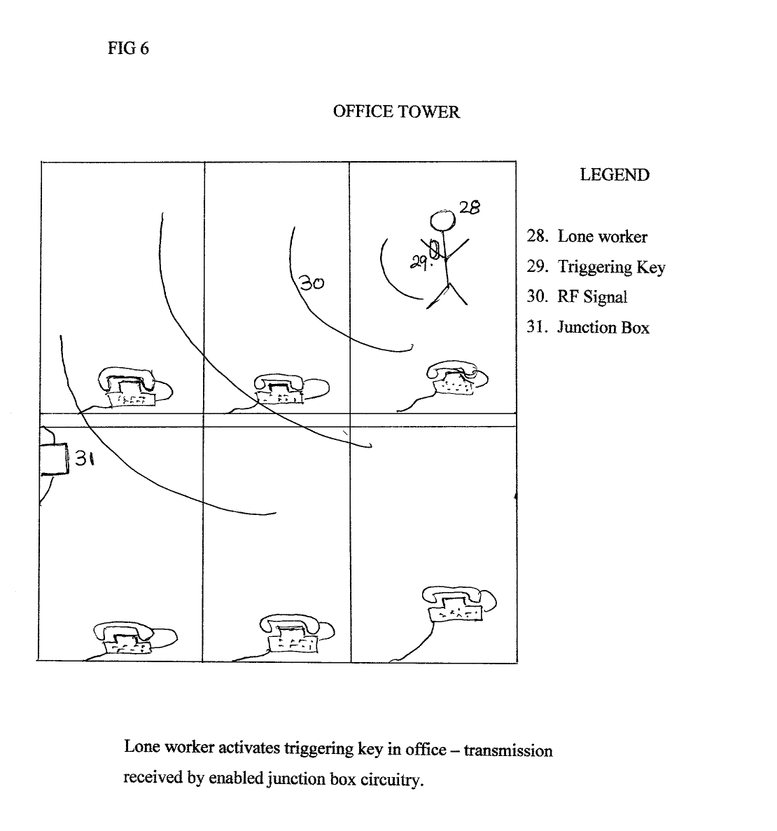

### DETAILED DESCRIPTION OF INVENTION

Two methods are used to install the 911 CELPHINDER technology with cellular telephones. The first method adapts an existing cell phone to a 911 CELPHINDER enabled cell phone by attaching an Interface Module to the cell phone. The Interface Module contains circuitry that transmits an RF signal that is activated by ‘dialing’ 911 on the enabled cell phone. The second method entails reducing the circuitry to a chipset. The chipset is then installed in the cell phone or Interface Module. Additionally, the Interface Module or chipset is either attached to, or build into a pager, PDA, or Triggering Key.

Two methods are used to install 911 CELPHINDER technology in a landline telephone. The circuitry that monitors and receives the transmission from the cell phone/Interface Module, and the pre dialing mechanism is housed in the landline telephone or telephone wall jack. This circuitry will also be reduced to chipsets. The Interface Module either uses its' own power source, or taps into the cells power source.

Existing Cell Phones

Most cellular telephones have a built-in interface connector that allows external communication with their internal functions. 911 CELPHINDER Interface Modules will interface with these cell phonies. The Interface Module contains a transmitter, which is activated by dialing the 911 sequence and transmits a signal, which seeks out the nearest 911 CELPHINDER enabled landline telephone. The landline telephone contains a built-in receiver that monitors the cell phone transmissions' specific frequency. Upon receiving the cell phones' RF signal the 911 pre-dialer is triggered, placing the 911 call to the 911 call center. (The 911 transmission contains a signature tone advising the call center the 911 call was placed from a cell phone. A specific signature will identify the cell phone). The landline customers' I.D. and address data is immediately displayed on the 911 operators' screen. (ie cell phone call—John Doe—1234 Main St. Down Town. The responding police officers are advised of the 911 cell phone status of the emergency call. In the event that more than one enabled landline responds to the 911 call, the operator can dismiss duplicate receptions (this can also be addressed by a software program installed in the 911 call center.

Another embodiment of the invention involves installing a transceiver in the cell phone or Interface Module which is activated when the cell phones user dials 911. The transmitted signal is received by a transceiver, contained in a nearby 911 CELPHINDER enables landline telephone. The landline transceiver is imprinted with the subscriber I.D. that is transmitted [returned] and decoded by the cell phone/Interface Module's transceiver. The subscriber data is transmitted via the cell phone to the cell provider (or directly to the 911-call center) where it is switched to the 911-Call Center/Public Safety Answering Point.

Note: The subscriber ID data usually includes name and address. The sub's ID could be shown as their telephone number, in which case the Call Center's computer will check the telephone number to determine the address etc.

### Office Buildings and Towers

911 Celphinder Enabled Landline Telephone

In order to provide precise location data to landline telephones in office towers and other buildings using PBX type master switching boxes, the following technological changes are made.

A business line bypasses the PBX switch that terminates at the office junction box is installed. The business line contains the imbedded 911 location (address) data.

911 CELPHINDER monitoring and pre-dialing circuitry is installed at the junction box/phone jack. 911 CELPHINDERS' transmitter circuitry is installed in the landline telephone.

When a 911 call is placed on a 911 CELPHINDER enabled landline telephone, the 911 CELPHINDER transmission and reception sequence take place, activating the pre-dialer that initiates the 911 call, providing full address data to the 911 operator, enabling responding police officers to go directly to the source of the 911 call. A 911 call placed by a 911 CELPHINDER enabled cellular telephone from the same office will obtain the same result.

Work Alone Personnel

Another embodiment of the invention is designed for surreptitious use. For example, work-alone personnel, especially female workers i.e. outside nurses, social service workers and real estate agent etc. will benefit from carrying a 911 CELPHINDER enables Triggering Key. The battery powered Triggering Key is designed to look like a commonly worn item i.e. watch, bracelet etc or worn beneath clothing. When activated (by squeezing etc) the Trigger Key transmits a signal (911 CELPHINDER frequency) that is intercepted by the monitor/receiving circuitry of the enabled landline, wall jack, junction box or landline telephone. This in turn, triggers the pre-dialer, relaying the 911 call to the 911 call center, and providing the landline subscribers address. Another method relaying the Triggering Keys' transmission is to add a receiver to the enabled cell phone. Upon receiving the Trigger Key's transmission, the receiving circuitry initiates the cell phones 911 dialing sequence. This approach can also be used by placing the receiving circuitry in the enabled landline telephone (office version) FIG

Another embodiment will reduce the circuitry contained in the Interface Module and landline telephone sets to a chipset. The chipsets accomplish the same functions outlined above and are built into the cell and landline telephones/wall jack/junction box.

Another embodiment uses Blue Tooth technology as part of 911 CELPHINDER'S circuitry. NOTE: The 911 CELPHINDER circuitry will not interfere with the normal function of either cell or landline telephone systems. Nor will it interfere with the usual transmission and reception of cell phone placed 911 calls.

Another embodiment of the invention is to add a GPS chip to the 911 CELPHINDER enabled cell phone. This will further enhance the overall effectiveness of the System by finishing location data when a 911 CELPHINDER enabled landline is unavailable.

Another embodiment of the Technology entails installing the cell phone interface/chipset with PDA's, pagers etc.

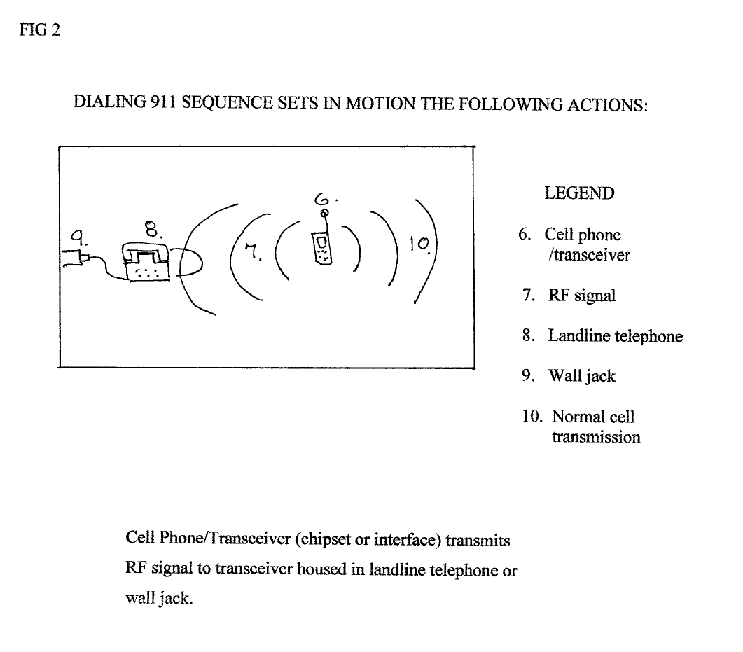

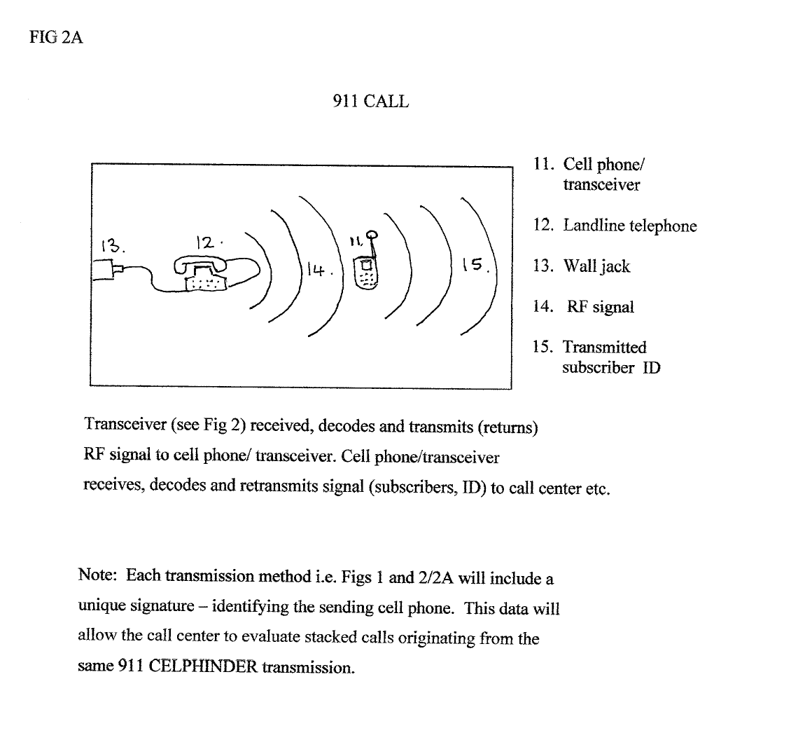

Another embodiment of the invention entails packaging a transceiver—with imprinted location data—in a small robust container. This stand alone version of the 911 CELPHINDER technology (hardwired or battery powered) can be placed anywhere, i.e. underground parking, garages, elevators, etc, or set-up in a city wide grid pattern—and react to a cell phone 911 call in the same manner as described in FIG. 2. The container, could also be attached to a landline and carry he necessary imbedded location data and initiate a 911 call when the RF etc signal is transmitted by the cell phone.

What is claimed is:

1. An enabled cellular telephone containing a transmission means
A. An Interface Module that connects to a cellular telephone and contains a transmission means
B. An enabled landline telephone containing a receiving and pre dialing means
C. An enabled wall jack containing receiving and pre dialing means
D. An enabled landline telephone containing a transmission means
E. An enabled cell phone having a transceiver means.
F. An enabled landline telephone having a transceiver means.
G. A Junction Box having a receiver and pre dialing means.
H. A triggering key having a transmission means.
I. A robust container for deployment having a transceiver
J. A robust container for deployment having a receiver and pre dialing means.
